(19) United States
(12) Patent Application Publication
(10) Pub. No.: US 2016/0003707 A1
(43) Pub. Date: Jan. 7, 2016

(54) METHOD AND APPARATUS FOR DETERMINING FAILURE IN OPTICAL MODULE FOR VEHICLE LAMP

(71) Applicant: Hyundai Motor Company, Seoul (KR)

(72) Inventor: Byoung Suk AHN, Suwon-si (KR)

(73) Assignee: Hyundai Motor Company, Seoul (KR)

(21) Appl. No.: 14/549,027

(22) Filed: Nov. 20, 2014

(30) Foreign Application Priority Data
Jul. 4, 2014 (KR) 10-2014-0083699

(51) Int. Cl. G01M 11/02; F21S 8/10

(52) U.S. Cl. CPC G01M 11/0285; F21S 48/10

(57) ABSTRACT

Disclosed are method and apparatus for determining failure in an optical module for a vehicle lamp. The method may include detecting at least one optical property information value of light generated in a light source, determining whether or not the detected optical property information value is within preset normal range values, determining that failure has occurred if the detected optical property information value deviates from the preset normal range values, and limiting an operation of the light source if it is determined that failure has occurred.

### CROSS REFERENCE TO RELATED APPLICATION

The present application claims priority of Korean Patent Application Number 10-2014-0083699 filed Jul. 4, 2014, the entire contents of which application are incorporated herein for all purposes by this reference.

### BACKGROUND OF INVENTION

1. Field of Invention

The present invention relates, in general, to an apparatus and method for determining failure in an optical module for a vehicle lamp, and, more particularly, to an apparatus and method for determining failure in an optical module for a vehicle lamp, which determines whether or not failure occurs in an optical module using a laser.

2. Description of Related Art

A vehicle lighting system generally includes a light source for generating light, a reflector for radiating light from the light source to the front of a vehicle, and a lens for refracting light reflected on the reflector.

Various luminous bodies are used as the light source. Conventionally, LEDs or halogen lamps have been generally used. However, recently a method for using a laser as a light source has come into use.

An example in which a laser is used as a light source is disclosed in a conventional art entitled “Lighting Fixture, Vehicle Headlamp, and Semiconductor Laser Array”. When a laser radiates light to a phosphor, the phosphor receives the laser light and emits light, with the result that the wavelength of the laser light is mixed with the wavelength of light generated by the phosphor, and thus a white or colored light is visible to person's eyes.

However, since laser light has strong energy and straightness, there is danger of amblyopia or blindness when laser light is directly radiated to a person's eyes or even just grazes the eyes. Therefore, if laser light does not pass through a phosphor and is directly radiated to a person's eyes because the phosphor deviates from its regular position or the phosphor is damaged, there has been severe damage of human life.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Accordingly, the present invention has been made keeping in mind the above problems occurring in the prior art and/or other problems, and the present invention is to provide an apparatus and method for determining failure in an optical module for a vehicle lamp, which can prevent damage of human life by determining whether laser light passes through a phosphor or the laser light does not pass through the phosphor and is directly exposed to the outside.

In various aspects, the present invention provides a method for determining failure in an optical module for a vehicle lamp, including detecting at least one optical property information value of light generated in a light source; determining whether or not the detected optical property information value is within preset normal range values; determining that failure has occurred if the detected optical property information value deviates from the preset normal range values; and limiting an operation of the light source if it is determined that failure has occurred.

The optical property information value may include a chromaticity value. The preset normal range values may be designated by a preset normal state coordinate area of color coordinates prepared in advance. The detected chromaticity value may be a coordinate value corresponding to the color coordinates prepared in advance.

Determining whether or not the detected optical property information value is within the preset normal range values may include determining that the optical module is in a normal state if the detected chromaticity value is within the normal state coordinate area of the color coordinates. Determining that failure has occurred may include determining that the optical module is in a state of failure if the detected chromaticity value deviates from the normal state coordinate area of the color coordinates.

Limiting the operation of the light source may include stopping the operation of the light source by blocking power applied to the light source.

Determining that failure has occurred may include outputting a failure alert signal to a driver if it is determined that failure has occurred; and limiting the operation of the light source by blocking power applied to the light source if the detected chromaticity value is within a preset operation limiting range of the color coordinates.

The optical property information value may include a light quantity value. Determining that failure has occurred may include determining that failure has occurred if the light quantity value is not within the normal range values. Determining that failure has occurred may include outputting a failure alert signal to a driver if it is determined that failure has occurred; and limiting the operation of the light source by blocking power applied to the light source if the detected light quantity value is within a preset operation limiting range.

Further, in various other aspects, the present invention provides an apparatus for determining failure in an optical module for a vehicle lamp, including a sensing unit for detecting at least one optical property information value of light generated in a light source; and a control unit for determining whether or not the detected optical property information value is within preset normal range values, determining that failure has occurred if the detected optical property information value deviates from the preset normal range values, and limiting an operation of the light source.

The light source may include a laser diode for generating laser light; and a phosphor for receiving the laser light and generating light having a different wavelength from a wavelength of the laser light.

The sensing unit may detect a chromaticity value of the laser light and light formed by the phosphor, and the control unit determines that the optical module is in a normal state if the detected chromaticity value is within a preset normal state coordinate area.

The apparatus may further include a filter for blocking the laser light between the sensing unit and the phosphor and passing the light generated in the phosphor, wherein the sensing unit detects quantity of the light passed through the filter.

The apparatus may further include a reflection unit for causing the laser light emitted from the laser diode to be reflected and to be incident upon the phosphor on a movement path of the laser light emitted from the laser diode.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart illustrating an exemplary method for determining failure in an optical module for a vehicle lamp according to a first embodiment of the present invention;

FIG. 2 is a graph illustrating a normal state coordinate area according to the first embodiment of the present invention;

FIG. 3 is a flowchart illustrating an exemplary method in which an operation limiting range is added to the method for determining failure in an optical module for a vehicle lamp according to the first embodiment of the present invention;

FIG. 4 is a diagram illustrating the configuration of an exemplary apparatus for determining failure in an optical module for a vehicle lamp according to the first embodiment of the present invention;

FIG. 5 is a flowchart illustrating an exemplary method for determining failure in an optical module for a vehicle lamp according to a second embodiment of the present invention;

FIG. 6 is a flowchart illustrating an exemplary method in which a drive limiting range is added to the method for determining failure in an optical module for a vehicle lamp according to the second embodiment of the present invention;

FIG. 7 is a diagram illustrating the configuration of an exemplary apparatus for determining failure in an optical module for a vehicle lamp according to the second embodiment of the present invention; and

FIG. 8 is a diagram illustrating an example of the arrangement of a sensing unit, a laser diode, and a phosphor according to the first embodiment and the second embodiment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims

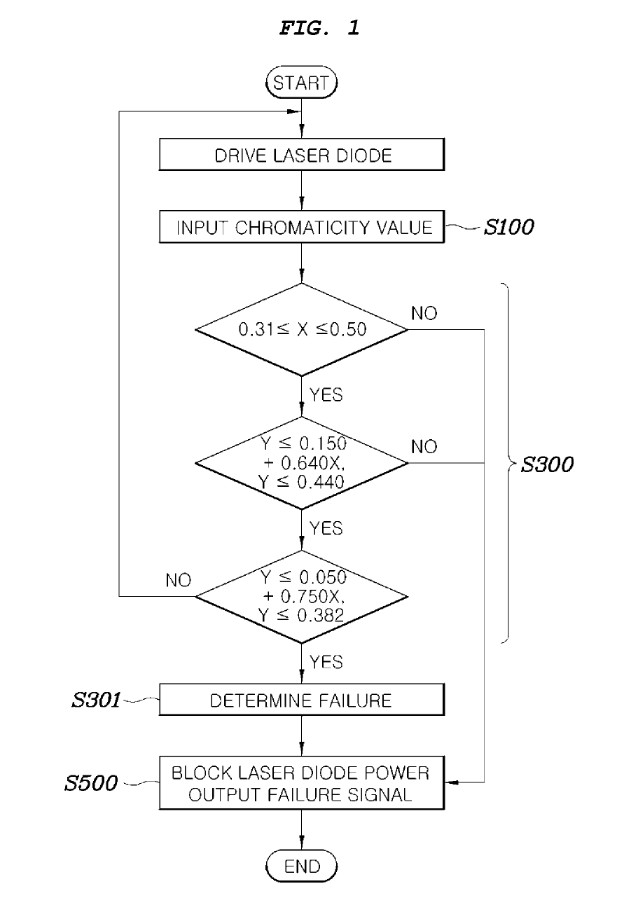

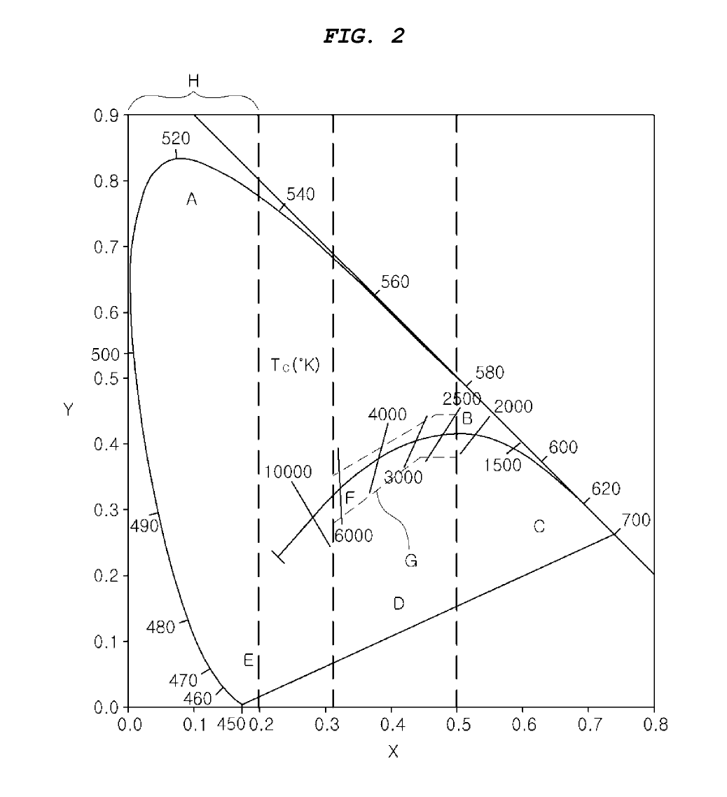

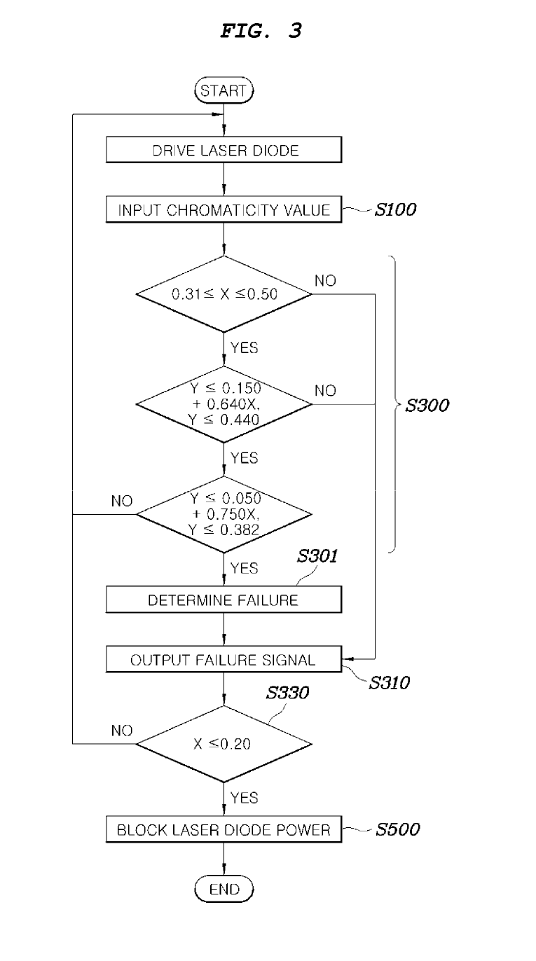

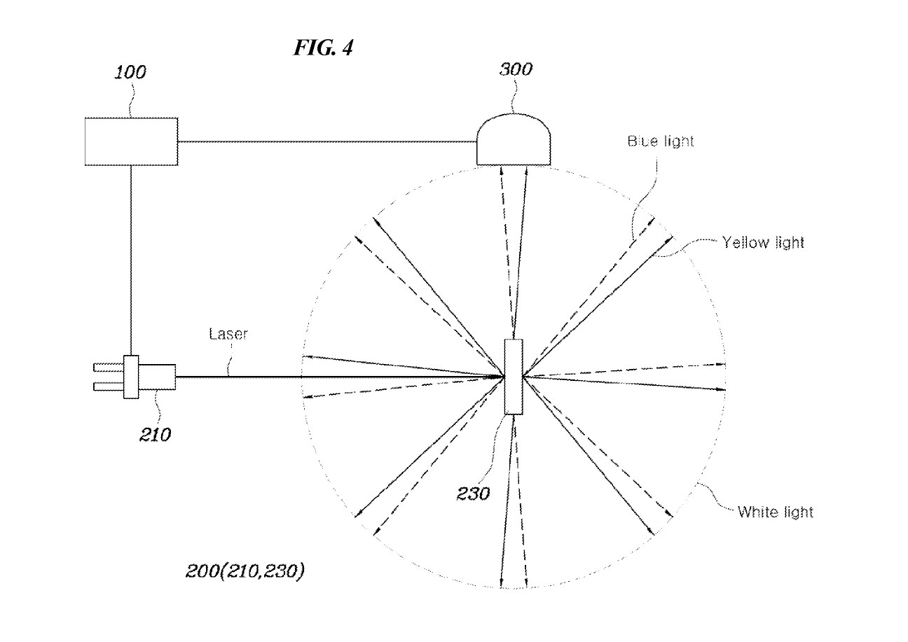

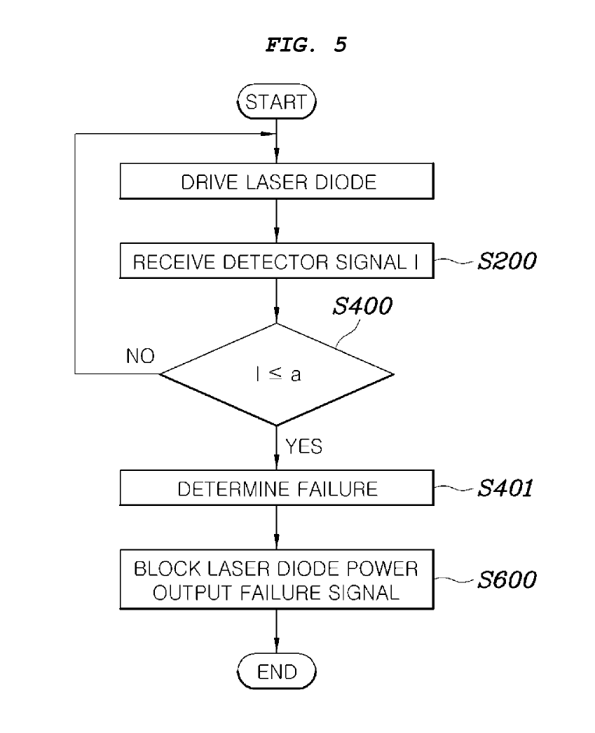

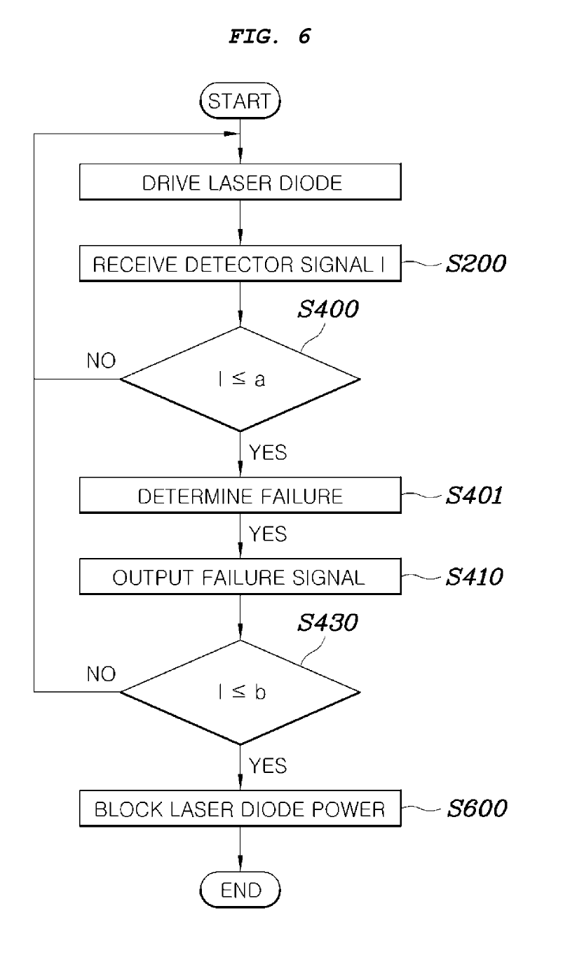

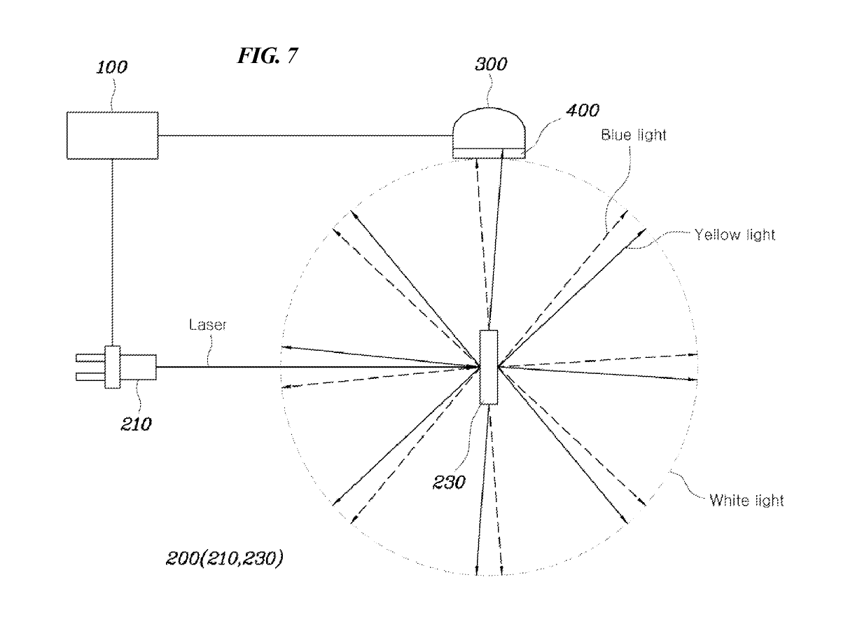

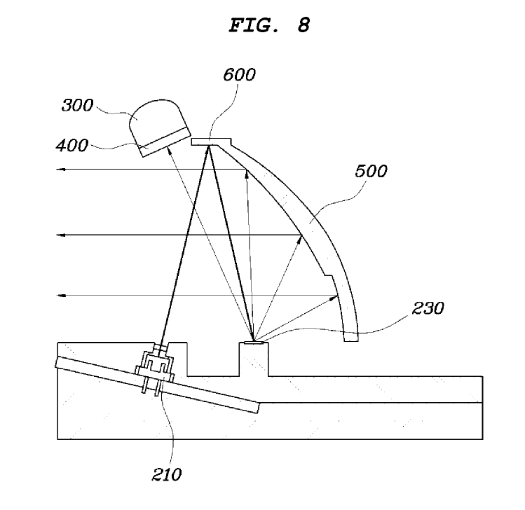

FIG. 1 is a flowchart illustrating a method for determining failure in an optical module for a vehicle lamp according to a first embodiment of the present invention; FIG. 2 is a graph illustrating a normal state coordinate area according to the first embodiment of the present invention; FIG. 3 is a flowchart illustrating a method in which an operation limiting range is added to the method for determining failure in an optical module for a vehicle lamp according to the first embodiment of the present invention; FIG. 4 is a diagram illustrating the configuration of an apparatus for determining failure in an optical module for a vehicle lamp according to the first embodiment of the present invention; FIG. 5 is a flowchart illustrating a method for determining failure in an optical module for a vehicle lamp according to a second embodiment of the present invention; FIG. 6 is a flowchart illustrating a method in which a drive limiting range is added to the method for determining failure in an optical module for a vehicle lamp according to the second embodiment of the present invention; FIG. 7 is a diagram illustrating the configuration of an apparatus for determining failure in an optical module for a vehicle lamp according to the second embodiment of the present invention; and FIG. 8 is a diagram illustrating an example of the arrangement of a sensing unit, a laser diode, and a phosphor according to the first embodiment and the second embodiment.

As shown in FIG. 1, the method for determining failure in an optical module for a vehicle lamp according to the first embodiment of the present invention includes: detecting at least one optical property information value of light generated in a light source at step S100; determining whether or not the detected optical property information value is included in preset normal range values at step S300; determining that failure has occurred when the detected optical property information value is not included in the preset normal range values at step S301; and limiting the operation of the light source when it is determined that failure has occurred at step S500.

The optical property information value may include various optical properties of light generated in the light source, such as the chromaticity value, the quantity value, the temperature value, and the intensity value of light generated in the light source. At detection step S100, one or more values may be detected from the various optical properties and may be used for later determination.

In the first embodiment of the present invention, a case in which failure is determined using the chromaticity value of the above values will be described, and, in the second embodiment, a case in which failure is determined using the light quantity value will be described. It is apparent that in some embodiments one optical property information value may be used and in some embodiments a plurality optical property information values may be detected and the plurality of optical property information values may be used as determination elements.

More specifically, in the first embodiment of the present invention, the chromaticity value of light generated in the light source may be detected at detection step S100. Here, the chromaticity value may be a coordinate value in which the chromaticity of light generated in the light source corresponds to color coordinates prepared in advance.

Further, at normal state determination step S300, the preset normal range values may be included in a preset normal state coordinate area of the color coordinates prepared in advance. At normal state determination step S300, it is determined to be a normal state when the detected chromaticity value is included in the normal state coordinate area of the color coordinates. At failure determination step S301, it is determined to be in a state of failure when the detected chromaticity value deviates from the normal state coordinate area of the color coordinates.

Normal state determination step S300 will be described in detail with reference to FIG. 2. FIG. 2 is a graph illustrating the normal state coordinate area of the color coordinates. In the color coordinates, A indicates a green area, B indicates a yellow area, C indicates a red area, D indicates a violet area, and E indicates a blue area. Each boundary between the areas is formed with a mixed area, generated in such a way that colors of two areas facing each other while interposing the boundary therebetween are mixed. The mixed area is similar to the conventional color coordinates.

A color at the center of the color coordinates, in which all areas overlap with each other, is included in a white area F. Although a normal state coordinate area G may be set in various manners depending on the intension of a designer, the normal state coordinate area G may be set for some of the white area F provided at the center of the color coordinates and the yellow area C adjacent to the white area F so as to realize a chromaticity area similar to that of the legally determined standard of white light for a vehicle.

Therefore, a setting may be made such that the normal state coordinate area G is a range in which an X axis satisfies a range that 0.310≦X≦0.500 and a Y axis satisfies a range that Y≧0.382, Y≧0.050+0.750x, Y≦0.150+0.640x, and Y≦0.440. It would be appreciated that the setting and/or other data disclosed herein are exemplary and non-limiting, and are readily adjustable.

When the detected chromaticity value does not satisfy the normal state coordinate area G, it is determined that the light source is currently in the state of failure at failure determination step S301. Thereafter, the operation of the light source may be stopped by blocking power applied to the light source at safety mode operating step S500.

Meanwhile, when it is determined that the light source is in the state of failure, safety mode operating step S500 may not be immediately performed as described above. As shown in FIG. 3, a failure alert signal is output to a driver at step S310, and it is determined whether or not the detected chromaticity value is included in the preset operation limits range H of the color coordinates at step S330. When the detected chromaticity value is included in the preset operation limiting range H of the color coordinates, safety mode operating step S500 may be performed.

Although the operation limiting range H may be set in various manners depending on the intension of the designer, the operation limiting range H may be a chromaticity area in which it may be determined that laser light is directly exposed to the outside, for example, an area of the color coordinates in which X≦0.20 in a light source including a laser diode and a phosphor which will be described later.

When the detected chromaticity value is positioned between the normal state coordinate area G and the operation limiting range H, for example, 0.20≦X≦0.31, it is preferable to continuously maintain the operation of the light source while the failure alert signal is output to the driver using warning sounds or an output on a display at step S310.

As above, safety mode operating step S500 is not immediately performed even when it is determined that the optical source is in the state of failure. Therefore, the operation of the light source is maintained even when it is determined that the light source is in the state of failure at nighttime traveling, and thus the driver can secure a view.

FIG. 4 is a diagram illustrating the configuration of an apparatus for determining failure in an optical module for a vehicle lamp using the method for determining failure in an optical module for a vehicle lamp according to the first embodiment of the present invention. The apparatus includes a sensing unit 300 for detecting at least one optical property information value of light generated in a light source 200; and a control unit 100 for determining whether or not the detected optical property information value is included in preset normal range values, determining that failure has occurred when the detected optical property information value deviates from the preset normal range values, and limiting the operation of the light source 200. Here, the sensing unit 300 may be a chromaticity sensor.

The light source 200 may include a laser diode 210 for generating laser light, and a phosphor 230 for receiving the laser light and generating light having a different wavelength from that of the laser light.

More specifically, in some embodiments, the laser light outputs a blue wavelength of 450 nm, and the phosphor 230 which receives the laser light generates a yellow wavelength of 570 nm. Light, lastly generated in the phosphor 230, is output in a state in which the blue wavelength is mixed with the yellow wavelength, and thus a person's eyes recognize that white light, in which a blue wavelength is mixed with a yellow wavelength, is output. It would be appreciated that the wavelengths or wavelength ranges disclosed herein are exemplary and non-limiting, and are readily adjustable.

In order to prevent the laser light from being directly exposed, the laser diode 210 may be arranged such that the laser light is always radiated to the phosphor 230. The sensing unit 300 may detect the chromaticity value of the laser light and light formed by the phosphor. The control unit 100 may determine whether or not the detected chromaticity value is included in the preset normal state coordinate area, and may determine a normal state when the detected chromaticity value is included in the preset normal state coordinate area.

If an abnormal state of the light source occurs, such as a case in which the laser light is exposed to the outside because the arrangement between the laser diode 210 and the phosphor 230 deviates or the laser light is exposed to the outside because the phosphor 230 is damaged, the chromaticity value of light generated in the phosphor 230 may deviate from the normal state coordinate area and may be inclined to the blue area. Here, the control unit 100 may block the leakage of the laser light by stopping the operation of the laser diode 210.

Detailed control of the light source, which includes the determination of a normal state or failure and is performed by the control unit 100, may be performed based on the method for determining failure according to the above-described first embodiment.

Meanwhile, FIG. 5 is a flowchart illustrating a method for determining failure in an optical module for a vehicle lamp according to a second embodiment of the present invention. In the second embodiment, the method includes detecting at least one optical property information value of light generated in a light source at step S200; determining whether or not the detected optical property information value is included in preset normal range values at step S400; determining that failure has occurred when the detected optical property information value deviates from the preset normal range values at step S401; and limiting the operation of the light source when it is determined that failure has occurred at step S600.

That is, although the second embodiment is similar to the first embodiment, a light quantity is detected instead of the chromaticity value of light at detection step S200. At failure determination step S401, when the detected light quantity value is not included in the normal range values, it is determined that the light source is in the state of failure, and the power of the light source may be blocked at safety mode operating step S600.

Here, it is preferable that the normal range values be values greater than a set reference value “a” which enables determining that the light source is in an abnormal state because the light quantity is reduced. It is apparent that various values may be set to the normal range values depending on the intension of the designer and the normal range values may be values included in a set interval.

Meanwhile, as shown in FIG. 6, when it is determined that failure has occurred at failure determination step S401, safety mode operating step S600 may not be immediately performed. After a failure alert signal is output to the driver at step S410 and it is determined whether or not the detected light quantity value is included in the preset operation limiting range at step S430, safety mode operating step S600 may be performed when the detected light quantity value is included in the preset operation limiting range.

The drive limiting range may include values which are less than a set reference value “b”, which enables determining that the light quantity generated in the phosphor is reduced because the laser light is exposed to the outside from among values which are less than the reference value “a” which enables determining that the light source is in the state of failure in the light source including the laser diode and the phosphor which will be described later.

If the detected light quantity value is included between the reference value “a” and the set value “b”, it is preferable to continuously maintain the operation of the light source while the failure alert signal is output to the driver using warning sounds or an output on a display.

As above, safety mode operating step S600 may not be immediately performed even when the state of failure is determined. Therefore, the operation of the light source is maintained even when it is determined that failure in the light source has occurred at nighttime traveling, and thus the driver can secure a view. This is similar to the first embodiment.

FIG. 7 a diagram illustrating the configuration of an apparatus for determining failure in an optical module for a vehicle lamp according to the second embodiment of the present invention. The apparatus for determining failure in an optical module for a vehicle lamp includes a sensing unit 300 for detecting at least one optical property information value of light generated in a light source 200; and a control unit 100 for determining whether or not the detected optical property information value is included in preset normal range values, determining that failure has occurred when the detected optical property information value deviates from the preset normal range values, and limiting the operation of the light source 200.

Here, the light source 200 may include a laser diode 210 for generating laser light, and a phosphor 230 for receiving the laser light and generating light having a different wavelength from that of the laser light.

Although the configuration according to the second embodiment is similar to that of the first embodiment, there is difference in that the apparatus further includes a filter 400 for blocking the wavelength of laser light between the sensing unit 300 and the phosphor 230 and passing the wavelength of light generated in the phosphor 230, and the sensing unit 300 detects the quantity of light which passes through the filter 400.

As described in the first embodiment, the laser light outputs a blue wavelength of 450 nm, and the phosphor 230 which receives the laser light generates a yellow wavelength of 570 nm. The filter 400 blocks a blue wavelength of 450 nm which is a short wavelength, and passes a yellow wavelength of 570 nm which is a long wavelength, and thus only a yellow wavelength of 570 nm is incident to the sensing unit 300. For this, although a Short Wave Pass (SWP) Filter may be used as the filter 400, the present invention is not limited thereto. Although a CdS cell or CdSe cell using a photo-resistance effect and a photodiode or phototransistor using a photovoltaic effect may be used as the sensing unit 300, the present invention is not limited thereto. Various embodiments are possible as the configurations of the filter 400 and the sensing unit 300.

If an abnormal state of the light source occurs, such as a case in which the laser light is exposed to the outside because the arrangement between the laser diode 210 and the phosphor 230 deviates or the laser light is exposed to the outside because the phosphor 230 is damaged, the quantity of light having a yellow wavelength of 570 nm output from the phosphor 230 may be reduced. Here, the control unit 100 may prevent the leakage of the laser light by stopping the operation of the laser diode 210.

Detailed control of the light source, which includes the determination of a normal state or failure and is performed by the control unit 100, may be performed based on the method for determining failure according to the above-described second embodiment.

As shown in FIG. 7, the filter 400 may be integrally coupled to the sensing unit 300 or may be independently provided between the sensing unit 300 and the phosphor 230.

FIG. 8 is a diagram illustrating an example of the arrangement of the sensing unit 300, the laser diode 210, and the phosphor 230 according to the first embodiment and the second embodiment. Although the laser diode 210 and the phosphor 230 may be mutually arranged in a line, the laser light emitted from the laser diode 210 may be reflected by a reflection unit 600, which is provided on the movement path of the laser light emitted from the laser diode 210 and is coupled to a reflector 500 or is independently provided, and may be incident to the phosphor 230. Further, the sensing unit 300 may sense the light of the phosphor 230 which emits light due to the laser light. According to the embodiment, the filter 400 may be provided between the sensing unit 300 and the phosphor 230.

According to the apparatus and method of the present invention for determining failure in an optical module for a vehicle lamp, it is possible to determine whether or not laser light is exposed to the outside due to the damage of the phosphor or the abnormal arrangement state of the laser and the phosphor and it is possible to cope with a situation based on the determination, and thus it is possible to prevent damage of human life from occurring.

Further, even when failure occurs, the laser is operated in a range where laser light is not directly exposed, and thus it is possible to prevent safety accidents due to difficulty in securing a front view during nighttime traveling.

For convenience in explanation and accurate definition in the appended claims, the terms upper or lower, front or rear, inside or outside, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof It is intended that the scope of the invention be defined by the Claims appended hereto and their equivalents.

What is claimed is:

1. A method for determining failure in an optical module for a vehicle lamp, comprising:
detecting at least one optical property information value of light generated in a light source;
determining whether or not the detected optical property information value is within preset normal range values;
determining that failure has occurred if the detected optical property information value deviates from the preset normal range values; and
limiting an operation of the light source if it is determined that failure has occurred.

2. The method of claim 1, wherein the optical property information value comprises a chromaticity value.

3. The method of claim 2, wherein the preset normal range values are designated by a preset normal state coordinate area of color coordinates prepared in advance.

4. The method of claim 3, wherein the detected chromaticity value is a coordinate value corresponding to the color coordinates prepared in advance.

5. The method of claim 4, wherein the determining whether or not the detected optical property information value is within the preset normal range values comprises:
determining that the optical module is in a normal state if the detected chromaticity value is within the normal state coordinate area of the color coordinates.

6. The method of claim 4, wherein the determining that failure has occurred comprises:
determining the optical module is in a state of failure when the detected chromaticity value deviates from the normal state coordinate area of the color coordinates.

7. The method of claim 1, wherein the limiting the operation of the light source comprises:
stopping the operation of the light source by blocking power applied to the light source.

8. The method of claim 4, wherein the determining that failure has occurred comprises:
outputting a failure alert signal to a driver if it is determined that failure has occurred; and
limiting the operation of the light source by blocking power applied to the light source if the detected chromaticity value is within a preset operation limiting range of the color coordinates.

9. The method of claim 1, wherein the optical property information value comprises a light quantity value.

10. The method of claim 9, wherein the determining that failure has occurred comprises:
determining that failure has occurred if the light quantity value is not within the normal range values.

11. The method of claim 10, wherein the determining that failure has occurred comprises:
outputting a failure alert signal to a driver if it is determined that failure has occurred; and
limiting the operation of the light source by blocking power applied to the light source if the detected light quantity value is within a preset operation limiting range.

12. An apparatus for determining failure in an optical module for a vehicle lamp, comprising:
a sensing unit for detecting at least one optical property information value of light generated in a light source; and
a control unit for determining whether or not the detected optical property information value is within preset normal range values, determining that failure has occurred if the detected optical property information value deviates from the preset normal range values, and limiting an operation of the light source.

13. The apparatus of claim 12, wherein the light source comprises:
a laser diode for generating laser light; and
a phosphor for receiving the laser light and generating light having a different wavelength from a wavelength of the laser light.

14. The apparatus of claim 13, wherein:
the sensing unit detects a chromaticity value of the laser light and light formed by the phosphor, and
the control unit determines that the optical module is in a normal state if the detected chromaticity value is within a preset normal state coordinate area.

15. The apparatus of claim 13, further comprising:
a filter for blocking the laser light between the sensing unit and the phosphor and passing the light generated in the phosphor,
wherein the sensing unit detects quantity of the light passed through the filter.

16. The apparatus of claim 13, further comprising a reflection unit for causing the laser light emitted from the laser diode to be reflected and to be incident upon the phosphor on a movement path of the laser light emitted from the laser diode.
